(19) United States
(12) Patent Application Publication
(10) Pub. No.: US 2011/0115810 A1
(43) Pub. Date: May 19, 2011

(54) GAMING DEVICE HAVING A COLOR REDUCTION FILTER AND RELATED METHODS

(75) Inventor: James Lawrence, Henderson, NV (US)

(73) Assignee: BALLY GAMING, INC., Las Vegas, NV (US)

(21) Appl. No.: 12/619,625

(22) Filed: Nov. 16, 2009

(51) Int. Cl. G09G 5/02; G06K 9/36; A63F 13/00

(52) U.S. Cl. 345/590; 382/166; 463/30

(57) ABSTRACT

Various embodiments are directed to gaming devices utilizing a color reduction filter. In one embodiment, the color reduction filter reduces the number of unique colors in a digital image presented on a gaming device from N to M where N>M. The color reduction filter maintains the color palette and clarity of the image with fewer colors while enhancing the effectiveness of file compression. As a result, the processing unit of the gaming device has more time to run various applications and has more available memory for computational processes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

Embodiments are directed to gaming devices having a color reduction filter.

### BACKGROUND

Over the years, gaming machines have grown in both sophistication and gaming features to maintain player interest. Gaming machines have gone from relatively simple devices providing a player with an opportunity to win cash awards to sophisticated, multi-media devices. Even more, the games presented on the gaming machines have become increasing intricate. For example, slot-style games may include five or more reels with twenty or more paylines. Furthermore, games may include one or more bonus games or different game modes that allow a player to participate in a community game or a tournament. Accordingly, with the increasing complexity of these games, there is a continuing need for gaming machines to have the capabilities to support these games.

### SUMMARY

Briefly, and in general terms, various embodiments are directed to gaming machines utilizing a color reduction filter. According to one embodiment, the color reduction filter is applied to digital still images or video clips to reduce the number of colors in the image while maintaining image clarity. In one method, presenting one or more digital images having a reduced number of colors on one or more displays of a gaming device includes: determining a number of unique colors in a digital image and assigning a node to each unique color; extracting nodes from the digital image by using a local average to process similar colors together, thereby reducing the number of unique colors in the digital image to produce a color-reduced image; dithering the color-reduced image; and presenting the color-reduced image on one or more displays of the gaming device.

In another method, presenting one or more digital images having a reduced number of colors on one or more displays of a gaming device includes: assigning an octree node to each unique color in a digital image, wherein the digital image has N colors; removing nodes from each level of the octree node to obtain a number of seeds in the digital image, wherein the seeds correspond to colors, and the digital image has M colors, wherein N>M; finding a centroid for each seed in the digital image; clustering seeds together for each M color in the digital image, wherein each M color is an average of each seed's cluster; dithering the digital image to add error back into the digital image to form a color-reduced image having M colors; and presenting the color-reduced image on a display of the gaming device.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a perspective view of one embodiment of a gaming device.

FIG. 2 is an enlarged perspective view of one embodiment of a player interface of the gaming device of FIG. 1.

FIG. 3 is an enlarged perspective view of another embodiment of a player interface of the gaming device of FIG. 1.

FIG. 4 is a flow diagram of one color reduction method applied to an image presented on the gaming device.

FIG. 5 is a block diagram of an exemplary node tree for a digital image.

FIG. 6 is a block diagram of one embodiment of the internal components of a gaming device shown in FIG. 1.

FIG. 7 illustrates one embodiment of a gaming system network including the gaming devices of FIG. 1.

### DETAILED DESCRIPTION

Various embodiments are directed to a color reduction filter. In one embodiment, the color reduction filter reduces the number of unique colors in an image presented on a gaming device from N to M where N>M. For example, one embodiment reduces the color in a digital image from approximately 26,000 colors (16-bit image) to approximately 256 colors (8-bit image) or less. The color reduction filter may be used for each frame of one or more video clips or one or more digital still images that are presented on any display on a gaming device. The color reduction filter maintains the color palette and clarity of the image with less colors while enhancing the effectiveness of file compression. As a result, the processing unit of the gaming device has more time to run various applications and has more available memory for computational processes.

It should be noted that the term gaming device is intended to encompass any type of gaming machine, including hand-held devices used as gaming machines such as cellular based devices (e.g. phones), PDAs, or the like. The gaming device can be represented by any network node that can implement a game and is not limited to cabinet based machines. The system has equal applicability to gaming machines implemented as part of video gaming consoles or hand-held or other portable devices. In one embodiment, a geo-location device in the hand-held or portable gaming device may be used to locate a specific player for regulatory and other purposes. Geo-location techniques that can be used include by way of example, and not by way of limitation, IP address lookup, GPS, cell phone tower location, cell ID, known Wireless Access Point location, Wi-Fi connection used, phone number, physical wire or port on client device, or by middle tier or backend server accessed. In one embodiment, GPS and biometric devices are built within a player's client device, which in one embodiment, comprises a player's own personal computing device, or provided by the casino as an add-on device using USB, Bluetooth, IRDA, serial or other interface to the hardware to enable jurisdictionally compliant gaming, ensuring the location of play and the identity of the player. In another embodiment, the casino provides an entire personal computing device with these devices built in, such as a tablet type computing device, PDA, cell phone or other type of computing device capable of playing system games.

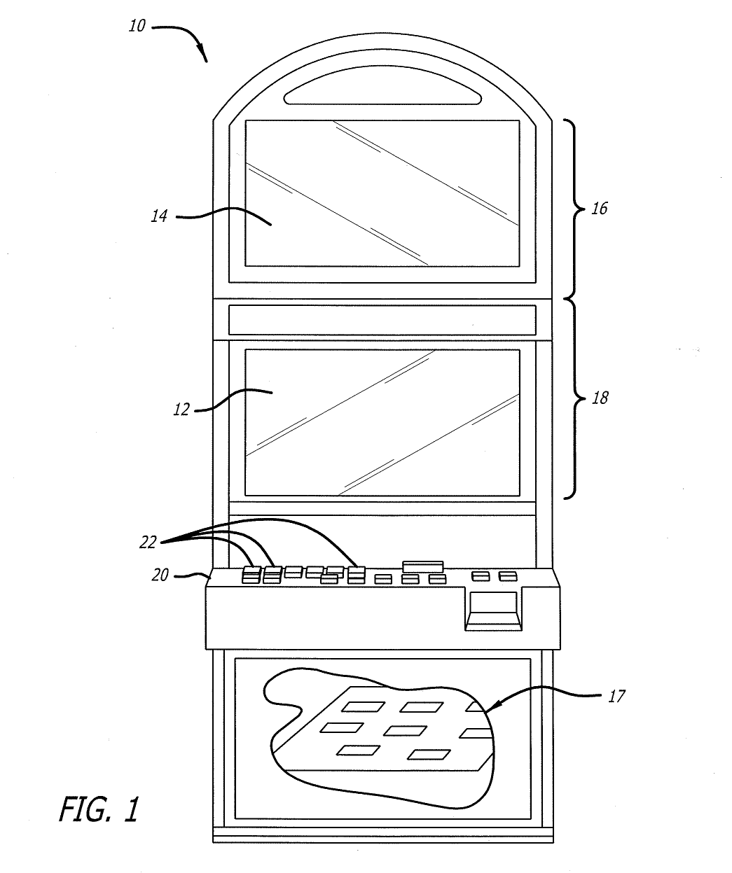

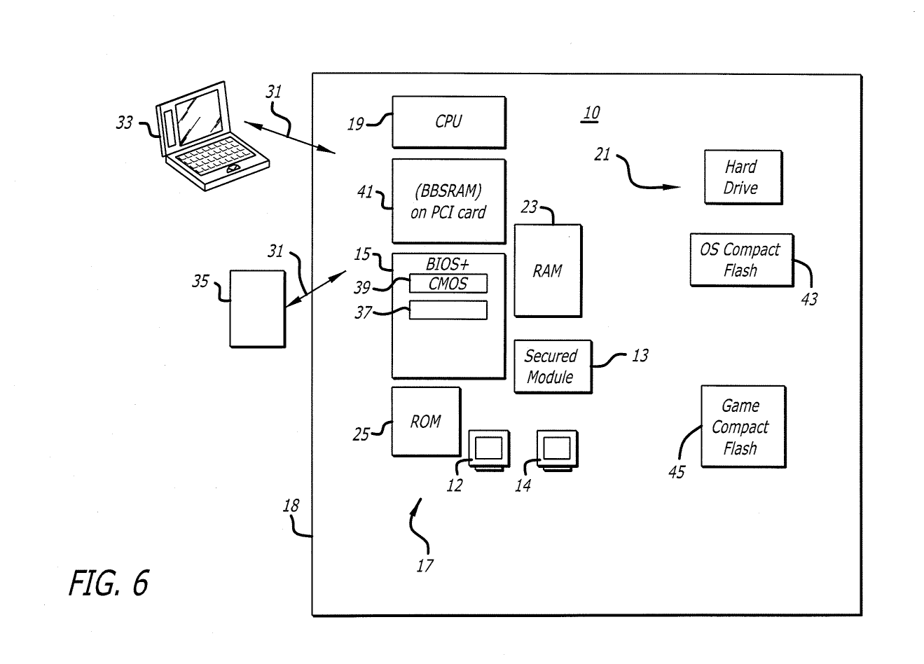

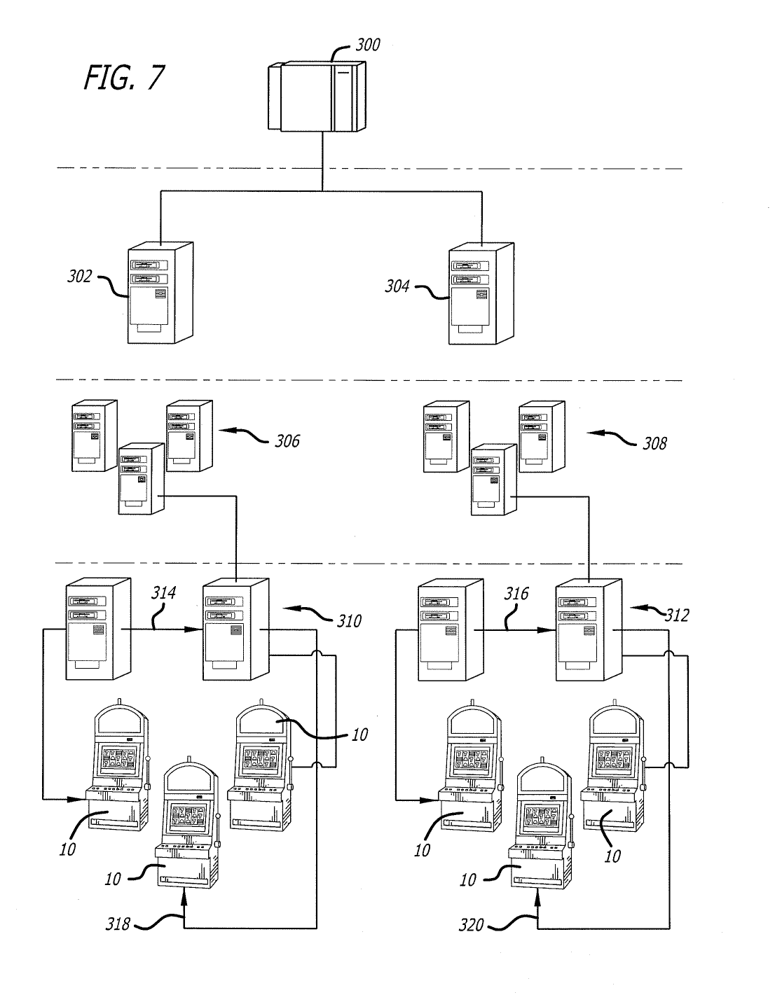

Referring now to the drawings, wherein like reference numerals denote like or corresponding parts throughout the drawings and, more particularly to FIGS. 1-6, there are shown various embodiments of a gaming device including one or more video displays that use a color reduction filter. More specifically, the gaming device 10 includes a main display 12 and a secondary display 14. The main display 12 and the secondary display 14 may be used to present a primary game or a secondary game. Additionally, the displays 12, 14 may present other gaming information such as, but not limited to, a pay table, game instructions, attract mode graphics or videos, celebration graphics or videos, tournament game information, group play information, jackpot information, progressive jackpot information, or any combination thereof. This gaming information may be associated with or include static images or video clips or images. The displays 12, 14 may also present non-gaming information news, advertisements, or promotions. Again, the non-gaming information may be associated with or include static images or video clips or images.

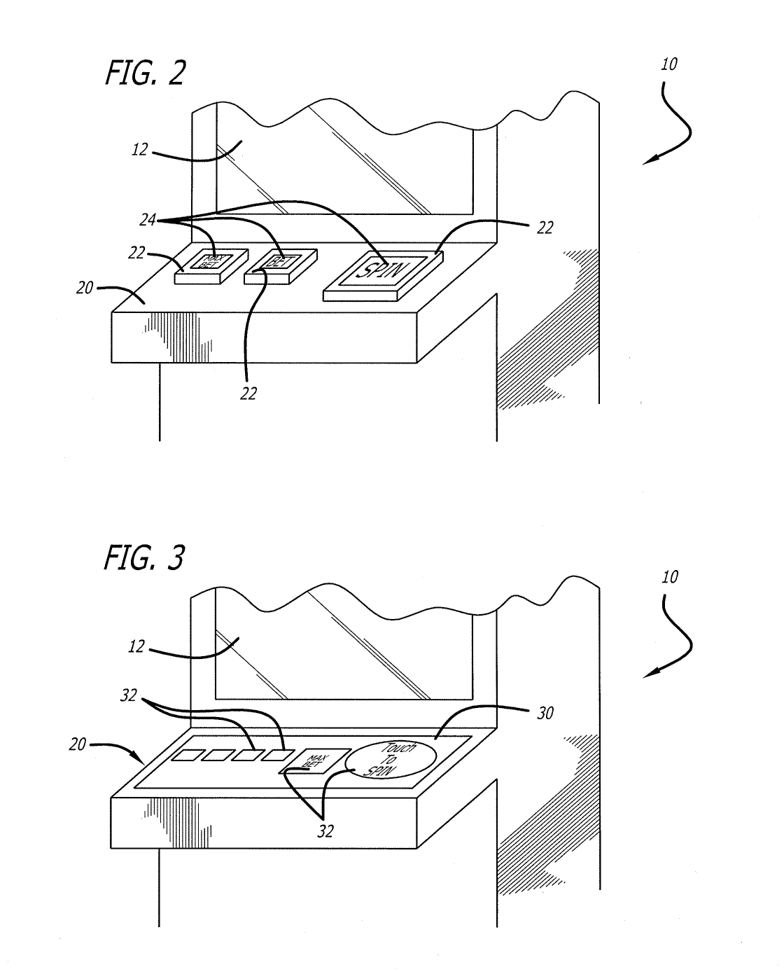

As shown in FIG. 2, player-activated buttons 22 are electromechanical buttons that include LCD or OLED displays 24 using a color reduction filter. The displays 24 allow the buttons 22 to be reconfigured for different functions by changing the image presented on the display. In addition to presenting different functions, the displays 24 on the buttons 22 may also present video or animation that is associated with the button function. For example, the display 24 may present a “spin” button which presents a video clip of spinning wheel after the button is pushed. Alternatively, the display 24 on each button 22 may present images or video clips that coincide with the theme of the game on the gaming device 10.

As shown in FIG. 3, the player interface 20 is a video display 30 incorporating a transparent, touch glass system (not shown) in which the video display uses a color reduction filter. The video display presents various images of buttons. Different button configurations, button shapes, button sizes, and button functions may be altered by changing the video image of the button. Additionally, video images and clips may be associated with the button 32.

According to one embodiment, the player interface 20 includes a touch glass system as disclosed in U.S. patent application Ser. No. 11/209,895, filed Aug. 21, 2005, which is hereby incorporated by reference. In yet another embodiment, the player interface 20 is a virtual button deck, as disclosed in U.S. patent application Ser. No. 11/938,203, entitled “Game Related Systems, Methods, and Articles that Combine Virtual and Physical Elements,” filed Nov. 9, 2007, which is hereby incorporated by reference.

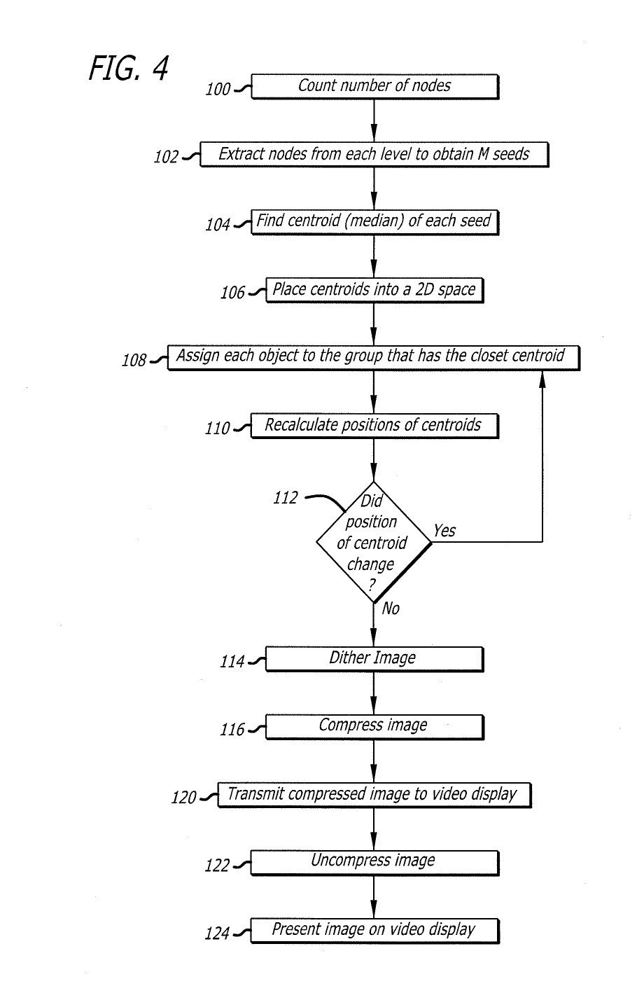

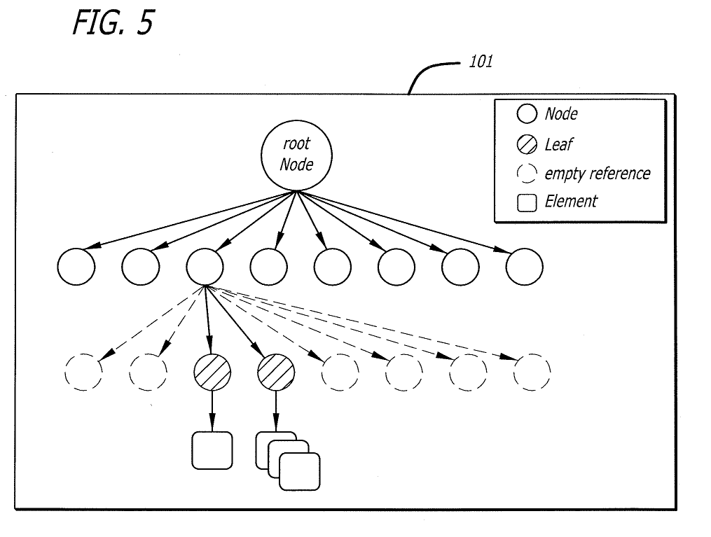

The color reduction method disclosed herein is a two-pass algorithm that processes the colors of an image from the top-level of the color hierarchy, and then uses a local average to process similar colors together. FIG. 4 illustrates one method for color reduction. As shown in step 100, the number of nodes in a color image is counted in order to form the set of colors in the RGB (red, green, blue) cube of possible colors. The color reduction method uses an Oct-Tree algorithm to count the nodes in the image into a RGB (Red, Green, Blue) color tree structure, but the color reduction does not use the pruning portion of the Oct-Tree algorithm. That is, the color reduction algorithm does not combine the children having least frequency with the least error from the original image. Generally, the color tree is an octree with a root node having eight nodes, and each node has eight leaves, and each leaf may have zero or more elements. An example of an octree 101 is shown in FIG. 5.

After all the unique colors are added, the octree is processed. At step 102, the octree is descended in breadth-first fashion (from depth 1 then to depth 2 and so on) to extract the depth's nodes to obtain M seeds. For each level, if the number of nodes plus the current seed set exceeds M, the current level is processed and descent to the next level is terminated. The last level to be processed only adds the most frequently occurring nodes to the seed set. After a level's nodes are added to the currend seed set, a pass is made over the current seed set to remove any nodes having eight direct children since the nodes are redundant. At step 104, after all of the level processing is completed, the seed set is further processed by assigning the final value for each seed as the median of all of the seed's children in the octree. As a result, the spread of the image color topology is obtained. In sum, the first pass of the algorithm is used to obtain the seeds of the image.

In one method, the resulting seeds may be used as the final colors of the image. Alternatively, the color reduction algorithm uses a second pass to process the seeds of the image. More specifically, a K-Means algorithm is applied to the seeds. At step 106, the color reduction algorithm places the initial group of centroids into a two-dimensional space. At step 108, each object to the group is assigned to the closest centroid. The position of each centroid is then recalculated at step 110. A determination of whether a centroid has changed positions occurs at step 112. If the position did not change, the clustering algorithm portion of the color reduction filter is ended. If the position of the centroid has changed, then the algorithm returns to step 108 for further processing. That is, the set of colors chosen is then computed as average of each seed's cluster, except the average must be within the seed's tree boundary by a settable amount. The seed's value is then replaced with the average, and step 110 is repeated several times to perform convergence.

Optionally, the color reduction filter performs one or more dithering passes at step 114. Dithering is a technique in which deviations caused by color reduction are added back to the image as the image is processed. Since the color reduction algorithm degrades the image by a certain amount, the dithering process adds a certain amount of color back into the image based on the amount of the image deviation in order to improve image quality.

The color-reduced image is then compressed at step 116. According to one method, color data is more effectively compressed at approximately 250% or better. The compressed image is transmitted to a video display at step 120. The image is uncompressed at step 122, and the color-reduced image is presented on the video display at step 124. Alternatively, the color-reduced image may be directly sent to the video display for presentation without any data compression.

Generally, the color reduction filter passes over a digital image two (or more) times. A first pass occurs from the top of the input colors to limit divergence, and a second pass starts from the bottom of the input colors to obtain the closest values. In another method, YUV may also be used in the color reduction filter to adjust for hue, chromance, and lighting. In yet another method, the color reduction filter may also use CMC (Color Management). In another method, the color reduction filter, disclosed herein, may use edge detection so that color reduction is weighted toward the focus.

Referring back to FIG. 1, the main cabinet 18 of the gaming machine 10 is a self-standing unit that is generally rectangular in shape. In the embodiment shown in FIG. 1, the main cabinet 18 is a slant-top gaming cabinet. Alternatively, in other embodiments, the gaming cabinet 18 may be a bar-top, table-top style cabinet, or any shaped cabinet known or developed in the art that is sized for a player to be able to sit or stand while playing a game. Additionally, the cabinet 18 may be manufactured with reinforced steel or other rigid materials that are resistant to tampering and vandalism. Optionally, in an alternate embodiment, the gaming machine 10 may instead be a cinema-style gaming machine (not shown), as disclosed in U.S. patent application Ser. No. 11/225,827, entitled “Ergonomic Gaming Cabinet,” filed on Sep. 12, 2005, which is hereby incorporated by reference.

As shown in FIG. 1, the gaming machine 10 includes a top box 16. According to one embodiment, the top box 16 is a separate and distinct component that is affixed to the main cabinet 18. In another embodiment, the top box 16 is an area that is partitioned from the main cabinet 18. Alternatively, the top box 16 and the main cabinet 18 may be contiguous areas with the outward appearance of two distinct components.

The top box 16 also includes a video screen 14. In a first mode or configuration, the video display may present the name of the game, pay table, other game information, tournament game information, or non-game related information (e.g., news, advertisements, or promotions). In a second configuration, the video screen 14 may present one or more bonus games in response to a triggering event. Optionally, the video screen 14 may also include a touch screen or touch glass system (not shown). The touch screen system allows a player to input choices without using any electromechanical buttons. Alternatively, the touch screen system may be a supplement to the electromechanical buttons.

As shown in FIG. 1, the gaming machine 10 includes a main display 12. According to one embodiment, the main display 12 is a plurality of mechanical reels for presenting a slot-style game. Alternatively, the main display 12 is a video display for presenting one or more games such as, but not limited to, mechanical slots, video slots, video keno, video poker, video blackjack, video roulette, Class II bingo, games of skill, games of chance involving some player skill, or any combination thereof.

According to one embodiment, the main display 12 is a widescreen display (e.g., 16:9 or 16:10 aspect ratio display). In one embodiment, the display 12 is a flat-panel display including by way of example only, and not by way of limitation, liquid crystal, plasma, electroluminescent, vacuum fluorescent, field emission, LCOS (liquid crystal on silicon), and SXRD (Silicon Xtal Reflective Display), or any other type of panel display known or developed in the art. These flat panel displays may use panel technologies to provide digital quality images including by way of example only, and not by way of limitation, EDTV, HDTV, or DLP (Digital Light Processing).

According to one embodiment, the widescreen display 12 may be mounted in the gaming cabinet 18 in a portrait or landscape orientation. In another embodiment, the game display 12, 14 may also include a touch screen or touch glass system (not shown). The touch screen system allows a player to input choices without using any electromechanical buttons 22. Alternatively, the touch screen system may be a supplement to the electromechanical buttons 22. In one embodiment, the touch screen is a transparent, flat surface that is spaced apart from the video display 20, as disclosed in U.S. patent application Ser. No. 11/209,895, filed Aug. 21, 2005, which is hereby incorporated by reference.

The main cabinet 18 of the gaming machine also houses a game management unit (not shown) that includes a CPU, circuitry, and software for receiving signals from the player-activated buttons 22 and a handle (not shown), operating the games, and transmitting signals to the respective game display 12, 14 and speakers (not shown). Additionally, the gaming machine 10 includes an operating system such as Bally Gaming's Alpha OS, as disclosed in U.S. Pat. No. 7,278,068, which is hereby incorporated by reference.

In various embodiments, game program may be stored in a memory (not shown) comprising a read-only memory (ROM), volatile or non-volatile random access memory (RAM), a hard drive or flash memory device or any of several alternative types of single or multiple memory devices or structures.

As shown in FIG. 1, the gaming machine 10 includes a plurality of player-activated buttons 22. These buttons 22 may be used for various functions such as, but not limited to, selecting a wager denomination, selecting a number of games to be played, selecting the wager amount per game, initiating a game, or cashing out money from the gaming machine 10. The buttons 22 function as input mechanisms. The buttons 22 may be mechanical buttons, electromechanical buttons or touch screen buttons. In another embodiment, one input mechanism is a universal button module that provides a dynamic button system adaptable for use with various games, as disclosed in U.S. patent application Ser. No. 11/106,212, entitled “Universal Button Module”, filed Apr. 14, 2005 and U.S. patent application Ser. No. 11/223,364, entitled “Universal Button Module”, filed Sep. 9, 2005, which are both hereby incorporated by reference. Additionally, other input devices, such as but not limited to, touch pad, track ball, mouse, switches, and toggle switches, are included with the gaming machine to also accept player input. Optionally, a handle (not shown) may be “pulled” by a player to initiate a slots-based game.

FIG. 3 illustrates the components 17 of one embodiment of a gaming device 10. The components 17 comprise, for example, and not by way of limitation, software or data file components, firmware components, hardware components, or structural components of the gaming machine 10. These components include, without limitation, one or more processors 19, a hard disk device 21, volatile storage media such as random access memories (RAMs) 23, read-only memories (ROMs) 25 or electrically erasable programmable ROMs (EEPROMS) such as basic input/output systems (BIOS) 15. Additionally, the gaming device 10 includes a secured module 13. The secured module is a hardware component that is one-time programmable. One or more security algorithms may be provided on the secured module. The security algorithm generates a challenge (e.g., generates a random number), calculates an expected response to the challenge, and determines the validity of the BIOS based on the response to the challenge provided by the BIOS. In one embodiment, the secured module is a field-programmable gate array (FPGA). In another embodiment, the secured module is a trusted platform module (TPM).

In one embodiment, components 17 also include data files (which are any collections of data, including executable programs in binary or script form, and the information those programs operate upon), gaming machine cabinets (housings) 27, displays 12, 14, or compact disk read-only memory (CDROM) or CD read-write (CD-RW) storage. In one embodiment, the data files may include data storage files, software program files, operating system files, and file allocation tables or structures. Ports 31 are be included with the gaming machine 10 for connection to diagnostic systems 33 and other input/output devices 35. In one embodiment, the ports 31 each comprise a serial port, universal serial bus (USB) port, parallel port or any other type of known port, including a wireless port. Preferably, each of the components 17 have embedded or loaded in them identification numbers or strings that can be accessed by the processor 19, including the processor 19 itself, which are utilized for authentication as explained below. In one embodiment, the components that are data files each use their file path and name as their identification number or string.

Either within the gaming machine 10, or in the diagnostic system 33 attachable to the gaming machine 10, are executable instructions or a software program 37 for authentication of the components (authentication software 37), which itself may be one of the components 17 to authenticate if it is internal to the gaming machine 10. In one embodiment, authentication software 37 is stored on a persistent storage media such as the hard disk device 21, ROM 25, EEPROM, in a complementary metal oxide semiconductor memory (CMOS) 39, in safe RAM comprising a battery-backed static random access memory (BBSRAM) 41, in one or more flash memory components 43, 45, or other type of persistent memory. In one embodiment, the authentication software 37 is stored in a basic input/output system (BIOS) 15 device or chip. BIOS chips 15 have been used for storing prior authentication software, such as previous versions of the BIOS+ chip used by Bally Gaming Systems, Inc. of Las Vegas, Nev. in their EVO gaming system. Placing the authentication software 37 in the BIOS 15 is advantageous because the code in the BIOS 15 is usually the first code executed upon boot or start-up of the gaming machine 10, making it hard to bypass the authentication process. Alternatively, in one embodiment, the authentication software 37 is stored in a firmware hub (FWH), such as Intel's 82802 FWH.

As an alternative, instead of, or in conjunction with, the hard disk device 21, another mass storage device is used, such as a CD-ROM, CD-RW device, a WORM device, a floppy disk device, a removable type of hard disk device, a ZIP disk device, a JAZZ disk device, a DVD device, a removable flash memory device, a hard card type of hard disk device, or solid state memory device.

One of ordinary skill in the art will appreciate that not all gaming devices will have all these components or may have other components in addition to, or in lieu of, those components mentioned here. Furthermore, while these components are viewed and described separately, various components may be integrated into a single unit in some embodiments.

In some embodiments, the gaming machine 10 is part of a gaming system connected to or with other gaming machines as well as other components such as, but not limited to, a Systems Management Server (SMS) and a loyalty club system (e.g., casino management personnel/system (CMP/CMS)). Typically, the CMP/CMS system performs casino player tracking and collects regular casino floor and player activity data. The gaming system may communicate and/or transfer data between or from the gaming machines 10 and other components (e.g., servers, databases, verification/authentication systems, and/or third party systems).

An embodiment of a network that may be used with the gaming device is illustrated in FIG. 4. The example network consists of a top level vendor distribution point 300 that contains all packages for all jurisdictions, one or more jurisdiction distribution points 302 and 304 that contain regulator approved production signed packages used within that jurisdiction or sub-jurisdiction, one or more Software Management Points 306 and 308 to schedule and control the downloading of packages to the gaming machine and one or more Software Distribution Points 310 and 312 that contain regulator approved production signed packages only used in the gaming establishment that it supports. The Software Distribution Points (SDPs) 310 and 312 can communicate with Systems Management Points (SMPs) 314 and 316, respectively as well as directly to one or more gaming machines 318 and 320. The system allows for rapid and secure distribution of new games, configurations, and OS's from a centralized point. It makes it possible to update and modify existing gaming machines with fixes and updates to programs as well as providing modifications to such files as screen images, video, sound, pay tables and other gaming machine control and support files. It provides complete control of gaming machines from a centralized control and distribution point and can minimize the need and delay of human intervention at the gaming machine. In one embodiment, the configuration control may be from the SDPs 310, 312 or from the gaming servers.

It should be noted that, while the color reduction filter has been described in the context of a gaming machine, the color reduction filter may be used in other devices or components having displays. By way of example, and not by way of limitation, other exemplary devices that may use color reduction include: a kiosk, a cashier device, a plasma signage, an amusement gaming device, an arcade gaming machine, a player tracking device, a home game console, an ATM banking machine, a point of sale system, a vending machine, a cellular phone, a personal digital assistant, a laptop computing device, an electronic wallet device, a smart card, a monetary input/output device, a biometric device, a personal media player, a lottery ticket purchase/redemption device, a monitor, a television, a facsimile device, a hand-held gaming device, or any other device that presents graphic and video images.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A method for presenting one or more digital images having a reduced number of colors on one or more displays of a gaming device, the method comprising:
determining a number of unique colors in a digital image and assigning a node to each unique color;
extracting nodes from the digital image by using a local average to process similar colors together, thereby reducing the number of unique colors in the digital image to produce a color-reduced image; and
presenting the color-reduced image on one or more displays of the gaming device.

2. The method of claim 1, further comprising dithering the color-reduced image prior to presenting the color-reduced image.

3. The method of claim 1, wherein presenting the color-reduced digital image further comprises:
compressing the color-reduced image;
transmitting the color-reduced image to one or more displays of the gaming device; and
uncompressing the color-reduced image prior to presenting the color-reduced image on one or more displays.

4. The method of claim 1, wherein extracting nodes from the digital image further comprises:
(a) finding the centroids of the nodes remaining in the digital image;
(b) placing the centroids into a two-dimensional space;
(c) assigning each object in the digital image to a group having the closest centroid; and
(d) recalculating the position of the centroids; and
(e) repeating step (c) and step (d) until the position of the centroid does not change.

5. The method of claim 1, wherein the one or more displays include a main display, a secondary display, a touch screen display, or a display positioned within one or more electromechanical buttons.

6. The method of claim 1, wherein the one or more digital images from a video clip.

7. A method for presenting one or more digital images having a reduced number of colors on a display of a gaming device, the method comprising:
assigning an octree node to each unique color in a digital image, wherein the digital image has N colors;
removing nodes from each level of the octree node to obtain a number of seeds in the digital image, wherein the seeds correspond to colors, and the digital image has M colors, wherein N>M;
finding a centroid for each seed in the digital image;
clustering seeds together for each M color in the digital image, wherein each M color is an average of each seed's cluster; and
presenting the color-reduced image on a display of the gaming device.

8. The method of claim 7, further comprising dithering the digital image to add error back into the digital image to form a color-reduced image having M colors.

9. The method of claim 7, wherein the display is a main display, a secondary display, a touch screen display, or a display positioned within one or more electromechanical buttons.

10. The method of claim 7, wherein presenting the color-reduced digital image further comprises:
compressing the color-reduced image;
transmitting the color-reduced image to one or more displays of the gaming device; and
uncompressing the color-reduced image prior to presenting the color-reduced image on one or more displays.

11. The method of claim 7, wherein the one or more digital images from a video clip.
